(19) United States
(12) Patent Application Publication
(10) Pub. No.: US 2008/0044561 A1
(43) Pub. Date: Feb. 21, 2008

(54) Surface Modification of Nanoparticles by Phosphorus-Containing Compounds in the Vapor Phase

(75) Inventors: Agnes De Leuze-Jallouli, St. Petersburg, FL (US); Gerald Fournand, St. Petersburg, FL (US); Susan M. Stanczyk, St. Petersburg, FL (US)

Correspondence Address: FULBRIGHT & JAWORSKI L.L.P., 600 CONGRESS AVE., SUITE 2400, AUSTIN, TX, 78701, US

(73) Assignee: Essilor International (Compagnie Generale d'Optique), Charenton-Le-Pont (FR)

(21) Appl. No.: 11/835,191

(22) Filed: Aug. 7, 2007

Related U.S. Application Data
(60) Provisional application No. 60/821,739, filed on Aug. 8, 2006.

(51) Int. Cl. B05D 1/12; B05D 1/02; B05D 7/24; B29B 9/00

(52) U.S. Cl. 427/180; 264/7; 427/214; 427/447

(57) ABSTRACT

The present invention relates to a process for modifying the surface of nanoparticles, comprising providing nanoparticles, activating the surface of said nanoparticles by treatment with energetic species, and treating said nanoparticles with at least one gaseous phosphorus-containing compound having at least one functional group selected from a phosphoric acid group, a phosphonic acid group, a phosphinic acid group, a phosphinous acid group, salts thereof and derivatives thereof, a phosphine group and derivatives thereof, a phosphine oxide group and derivatives thereof, a phosphite group and a phosphonium group, resulting in chemical grafting of said phosphorus-containing compound on the surface of the nanoparticles. The invention also relates to a method of preparation of a stabilized dispersion of nanoparticles using the above prepared nanoparticles.

### CROSS REFERENCE TO RELATED APPLICATIONS

This application claims priority to U.S. Provisional Application No. 60/821,739 filed Aug. 8, 2006, the entire disclosure of which is specifically incorporated by reference herein without disclaimer.

### BACKGROUND OF THE INVENTION

1. Field of the Invention

This invention relates to a process for surface modification of nanoparticles by surface activation followed by grafting in order to improve their dispersibility in organic or aqueous solvent. This process allows preparation of stabilized liquid dispersions of nanoparticles and coating compositions comprising such stabilized nanoparticles dispersions.

2. Description of Related Art

The dispersion in a liquid medium of nanoparticles obtained in a powder form is a technical problem which is difficult to solve as aggregation can occur in the solid phase and is difficult to break after its formation. Moreover, when nanoparticles are dispersed, another issue is then to keep them dispersed over a long period of time (at least one week, and preferably at least one month). The introduction of this dispersion into a coating formulation or a mixture of organic compounds can be another problem. The change of media can result into a destabilization of the dispersion and an aggregation of the nanoparticles.

Chemists are attempting to modify the surface of the nanoparticles to prevent their agglomeration as well as to improve their solubility and/or dispersibility in solvents, monomers, polymers, etc.

Recent examples in the literature have dealt with surface modification of nanoparticles by chemical grafting.

In U.S. Pat. No. 5,993,967, U.S. Pat. No. 6,033,781 and WO 97/38041, the nanoparticles are first dispersed in a solvent with a high shear mixer, and then a star-graft silicone polymer is added. This polymer coats the surface of the nanoparticles to prevent any agglomeration from occurring. This reaction is done in a fairly dispersed media to avoid any aggregation to occur during the coating process. This approach is rather complex, since it requires a final step of evaporation and the preparation of a polymer.

Patent application WO 02/45129 describes the use of siloxane-based polymers for encapsulation of crystalline nanoparticles, by adding said siloxane-based polymer to a dispersion of crystalline nanoparticles. The thus treated dispersion is then incorporated into a cross-linkable resin.

U.S. Pat. No. 4,994,429 discloses treating in a liquid medium metal oxide/hydroxide particles with an organic acid material having a phosphorus containing acid group and an additional acid group selected from sulfonic acid group, carboxylic acid group, phosphonic and phosphinic acid groups.

In U.S. Pat. No. 6,183,658, the nanoparticles are coated with a silicone coupling agent such as aminopropyltrimethoxysilane. In this process, the aggregation of the iron oxide during the coating process is prevented by the large excess of coupling agent added. Because of this, a purification step is then necessary to get rid off the excess. As it is well known from the art, the functionality of the surface modifying molecule used can be varied in order to allow the dispersion of the nanoparticles in different media.

The article “Hybrid composite materials containing magnetic non oxide nanoparticles” Mat. Res. Soc. Symp. Proc. Vol. 628, 2000 discloses treating a stable aqueous sol of maghemite (γ-Fe₂O₃) particles with a solution of phenylphosphonic acid, recovering the treated solid particles and dispersing the particles in an organic solvent, thus forming a stable organosol.

WO 03/016217, in the name of the applicant, describes a method of preparation of a stabilized dispersion of metallic nanoparticles comprising treating a dispersion of non-stabilized metallic nanoparticles with a stabilizing compound having at least one functional group selected from the group consisting of phosphoric and phosphonic acid and salts thereof, phosphine, phosphine oxide and phosphonium. The obtained dispersion is stable for at least one week.

As can be seen, surface modification of nanoparticles by chemical grafting has systematically been performed in a liquid medium.

Thus, a first object of the invention is to provide a new process for modifying the surface of nanoparticles, which is simple, and in particular which does not require the preparation and use of a polymer nor the use of a large excess of a coupling agent and of a cumbersome purification step, nor even a liquid phase treatment.

Another object of the invention is a method for preparing a dispersion of nanoparticles in a liquid medium, preferably an aqueous medium, which is stable, preferably for at least one week, at ambient temperature (25° C.).

### SUMMARY OF THE INVENTION

The inventors have devised a process based on treatment of surface-activated nanoparticles by at least one stabilizing agent in vapor phase. Gaseous or vaporizable phosphorous compounds have been found particularly efficient in terms of stabilizing dispersions of nanoparticles by modifying their surface.

To achieve the foregoing objects, and in accordance with the invention as embodied and broadly described herein, the present invention relates to a process for modifying the surface of nanoparticles, comprising:

a) providing nanoparticles; and

b) treating said nanoparticles with at least one gaseous phosphorus-containing compound having at least one functional group selected from a phosphoric acid group, a phosphonic acid group, a phosphinic acid group, a phosphinous acid group, salts thereof and derivatives thereof, a phosphine group and derivatives thereof, a phosphine oxide group and derivatives thereof, a phosphite group and a phosphonium group, resulting in chemical grafting of said phosphorus-containing compound on the surface of the nanoparticles; wherein prior to step b), the surface of said nanoparticles has been activated by treatment with energetic species.

In preferred embodiments, the energetic activation treatment, which may result in surface physical attack and/or chemical modification, is a plasma treatment and treatment with the phosphorous compound is effected by vacuum evaporation, using, as an evaporation device, an electrical circuit connected to a piece of steel wool onto which the at least one phosphorous compound is deposited.

The surface modified nanoparticles prepared according to the process of the invention are generally intended to be dispersed in a liquid medium in order to prepare a liquid coating solution for articles such as optical articles. One important advantage of the present invention is that the modified nanoparticles are more easily dispersible in the desired solvent or coating composition.

Another embodiment of the instant invention is a method of preparation of a stabilized dispersion of nanoparticles, comprising:

a) providing nanoparticles;

b) modifying the surface of said nanoparticles according to the above cited process; and

c) dispersing the nanoparticles resulting from step b) in a liquid medium.

Other objects, features and advantages of the present invention will become apparent from this description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DETAILED DESCRIPTION OF THE INVENTION AND PREFERRED EMBODIMENTS

The terms “comprise” (and any form of comprise, such as “comprises” and “comprising”), “have” (and any form of have, such as “has” and “having”), “contain” (and any form of contain, such as “contains” and “containing”), and “include” (and any form of include, such as “includes” and “including”) are open-ended linking verbs. As a result, a method, or a step in a method, that “comprises,” “has,” “contains,” or “includes” one or more steps or elements possesses those one or more steps or elements, but is not limited to possessing only those one or more steps or elements.

Unless otherwise indicated, all numbers or expressions referring to quantities of ingredients, reaction conditions, etc. used herein are to be understood as modified in all instances by the term “about.”

The process according to the invention requires performing surface modification of nanoparticles with at least one phosphorous reactant in gas phase. “Surface” does not necessarily indicate a uniform layer of material is present. For example, there may be portions with no material, or the surface may be unevenly thick.

Utilizing a gas phase is very advantageous, since it offers the possibility of working with more reactive compounds, leading to a better modification of the surface of the nanoparticles by grafting. It was found that it was necessary to perform beforehand a surface activation of the nanoparticles by treatment with energetic species. Such energetic treatment generates a very reactive surface, which improves the grafting efficiency.

As used herein, the term “nanoparticles” is intended to mean solid particles of which the majority has a size higher than or equal to 1 nm but inferior to 1 μm. Nanoparticles may be spherical or non spherical, elongated, and even nanocrystals.

In the framework of this invention, the particle size is its diameter if the particle is spherical and its highest length if the particle is not spherical (length of the primary axis of the nanoparticles, which is defined as the longest straight line that can be drawn from one side of a particle to the opposite side). Processes for determining the particle size include BET adsorption, optical or scanning electron microscopy, or atomic force microscopy (AFM) imaging.

Preferably, the nanoparticles used in the invention have a particle size of less than or equal to 100 nm, preferably less than or equal to 50 nm, more preferably less than or equal to 25 nm, even more preferably less than or equal to 15 nm. It is preferred that all nanoparticles satisfy these conditions. This size is particularly useful for applications such as optics, where nanoparticles must not significantly influence the transparency of the coatings in which they are comprised.

Nanoparticles may be organic, inorganic, or a mixture of both can be used. Preferably, inorganic nanoparticles are used, especially metallic or metalloid oxide, nitride or fluoride nanoparticles, or mixtures thereof. They are preferably in the form of a powder.

Using different types of nanoparticles allows making hetero-structured nanoparticles coatings. Preferably, the nanoparticles are metal oxide nanoparticles or SiO₂ nanoparticles. The metal oxide nanoparticles are generally prepared by oxidation at elevated temperature.

Nanoparticles do not need to have existing surface reactive groups. However, in one embodiment of the invention, nanoparticles comprise reactive groups attached to them that are capable of establishing at least one intermolecular bond with the inventive phosphorous compound(s), preferably a covalent bond. Reactive groups can be originally present in the structure of nanoparticles, for example hydroxyl groups (silanols) in SiO₂ which are capable of binding with a large variety of phosphorous compound, and in particular those containing an additional reactive silane group, such as an alkoxysilane group.

Reactive groups can also be introduced at the surface of nanoparticles with or without existing reactive groups, for example by chemical grafting. Examples of reactive groups which may have been created are, without limitation, ethylenically unsaturated groups such as (meth)acrylate or vinylic groups, epoxides, isocyanates, silanes, siloxanes, silicates, silanols, thiols, alcohols.

When organic nanoparticles such as thermoplastic nanoparticles are used, they may comprise groups capable of establishing a covalent bond with the phosphorous compound which will be chemically grafted (or “attached” or “anchored” or “chemically anchored”), for example hydroxyl groups.

In accordance with the process of the invention, the nanoparticles which will undergo a grafting reaction with the at least one phosphorus-containing compound have to be treated beforehand with energetic species for a certain amount of time, resulting in activation of their surface.

By energetic species, it is meant species with an energy ranging from 1 to 150 eV, preferably from 10 to 150 eV, and more preferably from 40 to 150 eV. Energetic species may be chemical species such as ions, radicals, or species such as photons or electrons.

Treatment with energetic species of the nanoparticles can be performed at any pressure, under vacuum or at atmospheric pressure. When it is performed under vacuum, the pressure is generally lower than 70 Pa, preferably lower than 30 Pa.

The present energetic treatments are first intended to improve the bindability properties of the nanoparticles to the phosphorous compound to be grafted. Herein, it is believed that treatment with energetic species activates the surface of the nanoparticles by altering the chemistry of a few outermost molecular layers.

Good binding ability generally requires strong interfacial forces via chemical compatibility and/or chemical bonding. The present energetic treatments can assist in creating chemically active functional groups at the surface of the nanoparticles, such as amine, carbonyl, hydroxyl and carboxyl groups. For instance, using an oxygen gas plasma may create hydroxyl functionalities by oxidizing the surfaces.

The present energetic treatments are also used to control surface energy of the nanoparticles. It is preferred that the energetic treatment of the invention imparts to the nanoparticles a surface energy of at least 60 mJ/m², preferably at least 72 mJ/m². The treatment time, which depends on the nature of the nanoparticles, may be varied so as to reach the desired surface energy.

The energetic treatments in accordance with the present invention may also perform a surface cleaning, which is a safe and environmentally friendly alternative to traditional cleaning methods. For example, gas plasma treatments may remove organic surface contamination from the materials used. The active energetic species create chemical reactions with the contaminants, resulting in their volatilization and removal from the vacuum chamber.

Examples of treatments with energetic species are, without limitation: a vacuum plasma treatment, an atmospheric pressure plasma treatment, a glow discharge plasma treatment, a corona discharge treatment, an ion beam bombardment, in particular with an ion gun (especially with rare gases, oxygen, nitrogen, air or mixtures thereof), or an electron beam bombardment.

According to the invention, the preferred treatment with energetic species is a plasma treatment, more preferably a vacuum plasma treatment. Plasma can be defined as a partially (low temperature plasma) or wholly (high temperature plasma) ionized gas with a roughly equal number of positively and negatively charged particles.

Plasma can be generated by submitting a gas to a high voltage or high temperature arc (discharge). The source of the electric energy, which will energize the gas and ionize atoms and molecules, can be a DC or an AC current, radio frequency, or microwaves. The sources are connected to electrodes where the samples are set between.

The energetic species in gas plasma include ions, electrons, radicals, metastables, and photons in the short-wave ultraviolet (UV) range. Materials in contact with the gas plasma are bombarded by these energetic species and their energy is transferred from the plasma to those materials. These energy transfers are dissipated within the materials by a variety of chemical and physical processes (functionalization, grafting, etching, cross-linking . . . ) to result in a unique type of modification. In case of surface treatment, the bulk properties of the material are not altered.

A wide variety of processing parameters can be varied to affect the physical characteristics of the plasma used herein, and subsequently affect the surface chemistry obtained by plasma modification. Those parameters are, for example, treatment power, treatment time and operating pressure. This broad range of parameters offers greater control over the plasma process than that offered by most high-energy radiation processes.

Practically, the treatment time and treatment power required to successfully implement the process of the invention can be easily determined by the person skilled in the art.

When the nanoparticles have been energetically treated, the gas phase treatment step with the inventive phosphorus-containing compound can be implemented.

In a preferred embodiment, no treatment with energetic species is performed during the gas phase grafting step, which means that the energetic treatment is stopped once achieved, for example once a satisfactory surface energy is obtained, and then the gas phase grafting step can be started. However, treatment with energetic species of the nanoparticles can be continued during the whole grafting step or only part of it, without altering the process.

If nanoparticles are treated with gaseous phosphorous compounds without having been previously treated with energetic species, adhesion problems are encountered. Surface of the nanoparticles is not sufficiently reactive to undergo appropriate chemical modification. Thus, the treated nanoparticles may be subject to agglomeration when dispersed in a liquid coating solution, resulting in a coating with high haze.

Preferably, the gas phase treatment is performed by vacuum evaporating the phosphorous compound by means of an evaporation device, resulting in the grafting of the evaporated phosphorous compound onto the activated surface of the nanoparticles.

Various evaporation devices can be used in accordance with the process of the invention, such as devices based on ion or electron beam heating methods, devices based on high-frequency heating method, devices based on optical heating method (for example such device comprising a tungsten lamp), a Joule effect device or resistance heating device, and more generally any heating device which provides sufficient heat to evaporate the at least one phosphorous compound. Those devices are well known in the art. In a preferred embodiment, the evaporation device is an electron gun or a Joule effect device, most preferably a Joule effect device.

In one embodiment of the invention, said Joule effect device comprises an electrical circuit connected to a piece of steel wool onto which the at least one phosphorous compound is deposited. When an electrical current (an alternating current or a direct current) goes through the steel wool, the at least one phosphorous compound is evaporated. The power and the time required to evaporate the at least one phosphorous compound depend on the nature of the phosphorous compound used. In the case when a piece of steel wool is employed, the power and the time required also depend on nature of the piece of steel wool.

In another embodiment of the invention, the phosphorous material is poured in a capsule such as a copper capsule, in turn placed in a Joule effect carrier such as a tantalum or molybdenum crucible, which can be heated at a temperature around 400° C. to allow evaporation. Alternatively, the phosphorous material can be heated through an electron beam directed towards the carrier.

Vacuum evaporation is generally performed herein under a pressure lower than 70 Pa, preferably lower than 40 Pa and more preferably lower than 30 Pa. The working pressure may be as low as is technically permitted by the vacuum chamber employed, for example from 10⁻³ to 10⁻¹ Pa.

Practically, since energetic treatments need not to be conducted under vacuum while this feature is generally a requirement for the gas phase grafting step, vacuum has to be drawn in the vacuum chamber preferably at the end of the energetic treatment so that the grafting can be started, unless the energetic treatment was performed under a vacuum suitable for the subsequent grafting step, which can then be performed without pressure modification.

The process of the invention is made easier if the same pressure is employed during the energetic treatment and gas phase grafting steps. The gas phase treatment with the at least one phosphorous compound can be started immediately after having achieved the energetic treatment of the nanoparticles.

In the present application, the inventive chemical grafting reaction is the reaction between a functional group on the nanoparticle and a functional group on the phosphorus-containing compound.

The gas phase treatment with the inventive phosphorous compound results in the chemical modification of the surface of the nanoparticles. Indeed, the phosphorous compound is a compound capable of establishing at least one intermolecular bond or interaction with a functional group that is present at the surface of the nanoparticles, preferably at least one covalent bond.

During the gas phase treatment of the nanoparticles with at least one phosphorous compound, which will be referred to as “the grafting step”, chemical reactions such as addition or substitution reactions known to those skilled in the art of organic synthesis are carried out with the appropriate reaction pairs as known in the art to graft a wide range of phosphorus-containing compounds to the nanoparticles surface. When the desired grafting level is reached, the treatment is ceased.

The phosphorus-containing compounds which are used in the present invention to chemically modify the surface of the nanoparticles have at least one functional group selected from a phosphoric acid group, a phosphonic acid group, a phosphinic acid group, a phosphinous acid group, salts thereof and derivatives thereof, a phosphine group and derivatives thereof, a phosphine oxide group and derivatives thereof, a phosphite group and a phosphonium group. They will generally be referred to as “the phosphorous compounds.”

Said phosphorus-containing compounds are gaseous or can be vaporized by heating under vacuum. Preferably, such compounds or mixtures of compounds are liquid at room temperature and atmospheric pressure, or can be rendered liquid by heating, thus being in a suitable state for evaporation.

Among these compounds, there may be cited, without limitation, phosphoric acid (H₃PO₄), phosphonic acid (H₃PO₃, also known as phosphorous acid), phosphinic acid (H₃PO₂, also known as hypophosphorous acid and phosphorous acid) and phosphinous acid (H₃PO), hypophosphoric acid (H₄P₂O₆), salts and derivatives thereof, phosphines such as triarylphosphines, phosphine oxides and derivatives, phosphites such as trialkylphosphites, phosphonium compounds such as tetraaryl phosphonium salts.

Derivatives of those compounds include nitrogen derivatives thereof, such as phosphoramides, phosphinimines, and sulfur derivatives thereof, such as phosphine sulfides.

The chemical functionality of the phosphorous compounds used to treat the nanoparticles can be adjusted in order to be able to use a dispersion of those nanoparticles in different organic media.

In addition, the phosphorus-containing compounds of the invention may comprise at least one additional group able to establish a covalent bond with the nanoparticles, for example acid groups such as sulfonic acid, sulfinic acid, or carboxylic acid groups, isocyanate groups, vinyl groups, siloxane or silane groups such as alkoxysilane groups. Preferably, non polymeric phosphorus-containing compounds are used; in particular no phosphorus-containing compound having a polysiloxane group is used.

That means phosphorous compounds having an additional alkoxysilane group are preferably vaporized under a monomer form. Even if some polymerization may further occur in situ once the treated nanoparticles are dispersed in the liquid medium, a primary reaction has to occur at the surface of the nanoparticles with said phosphorous-containing compound, without beginning any substantial polycondensation of the alkoxysilane functional groups.

As examples of phosphorous compounds usable in the invention, one can cite:

1,3-bis(diphenylphosphino)propane, 2-(diphenylphosphino)benzoic acid, 2-(diphenylphosphino)ethyl triethoxysilane, 4-(diphenylphosphino)benzoic acid, diethylphosphatoethyl triethoxysilane, diphenylphosphate, diphenylphosphine oxide, diphenylphosphonic acid, metaphosphoric acid, sodium polyphosphate, tris(2,4,6-trimethoxyphenyl)phosphine, tris(trimethylsylil)phosphate, vinylphosphonic acid, vinyltriphenylphosphonium bromide, trimethyl 2-phosphonoacrylate, diethoxyphosphinyl isocyanate and triphenylphosphine.

Preferred phosphorous compounds are phosphoric acid (H₃PO₄), 2-(diphenylphosphino) benzoic acid, diethylphosphatoethyl triethoxysilane and mixtures thereof.

The phosphorous material used for surface modification of the nanoparticles may comprise one or more of the above cited compounds.

An effective amount of phosphorous material should be used during the chemical grafting treatment, i.e., an amount sufficient to obtain a stable dispersion after dispersing the nanoparticles in a liquid medium. That is the reason why the inventive phosphorous compounds can be seen as stabilizing compounds and the phosphorous groups listed above can be regarded as stabilizing groups.

Usually, the amount of phosphorous compound to be used during step b) of the inventive process ranges from 2 to 30%, preferably from 3 to 20% and more preferably from 5 to 15% by weight based on the weight of nanoparticles involved in the surface modification process.

The surface-modified nanoparticles are generally obtained in the form of a powder.

The invention also relates to a method of preparation of a stabilized dispersion of nanoparticles, preferably an aqueous dispersion, comprising:
a) providing nanoparticles;
b) modifying the surface of said nanoparticles according to the above described surface modification process; and
c) dispersing the nanoparticles resulting from step b) in a liquid medium.

The nanoparticles can be added and mixed to the liquid medium in a classical manner. The dispersion is optionally obtained with the aid of a bath sonicator, a high shear mixer or a magnetic stirrer.

Typically, the amount of nanoparticles present in the final stabilized dispersion of the invention ranges from 5 to 50%, preferably from 9 to 40% by weight relative to the total weight of the dispersion.

In some cases, depending on the future use, it is necessary to remove the larger size nanoparticles (size>30 nm) by filtration, centrifugation, etc. after the treatment of the nanoparticles with the phosphorous compound(s). Preferably, the nanoparticles used to prepare the dispersion have a particle size of less than or equal to 50 nm, more preferably less than or equal to 25 nm, even more preferably less than or equal to 15 nm.

The liquid medium in which the nanoparticles are dispersed can be any known liquid or mixtures of liquids typically used for preparing particles dispersions. It can be water, an organic solvent or a mixture thereof. Preferred organic solvents are alcohols such as methanol, ethanol. The preferred liquid medium is an aqueous medium such as water or a mixture of water and a water miscible alkanol.

The liquid medium preferably has an acidic pH. It may optionally comprise one or more phosphorus-containing compounds having at least one functional group selected from a phosphoric acid group, a phosphonic acid group, a phosphinic acid group, a phosphinous acid group, salts thereof and derivatives thereof, a phosphine group and derivatives thereof, a phosphine oxide group and derivatives thereof, a phosphite group and a phosphonium group. Those phosphorus-containing compounds help to further stabilize the dispersion and are such as described above. An example is H₃PO₄, which also helps to reduce the pH of the liquid medium.

The dispersion of treated nanoparticles according to the invention is stable overtime, preferably for at least one week at ambient temperature (25° C.), more preferably for several months at ambient temperature on a bench top, due to the stabilizing effect dispensed by the grafted phosphorus-containing compound(s). That means agglomeration of the nanoparticles is prevented. The stability of the prepared dispersion can be evaluated by naked eye observation of the dispersion over time (separation or not), or with a high resolution particle size analyzer.

The dispersion of the present invention can be used in different media and in particular for formulating different organic coating compositions typically used for coating optical and/or ophthalmic substrates such as ophthalmic lenses or lens blanks.

A coating composition can be obtained upon addition of at least one binder and optionally a surfactant and a curing catalyst to the inventive stabilized dispersion.

The preferred organic coating compositions are those which contain as the main components an epoxy alkoxy silane and/or an alkyl alkoxy silane as a binder system, in the presence of a catalyst system or a hydrolyzate thereof.

Examples of such coating compositions are coating formulations with γ-glycidoxypropyl trimethoxysilane (GLYMO), acryloxypropyl trimethoxysilane or diethylphosphatoethyl triethoxysilane in the presence of a catalyst system, for example aluminium acetylacetonate or a combination aluminium acetylacetonate/cationic catalyst or a mixture itaconic acid/dicyandiamide.

The optical articles coated from a coating composition prepared according to the invention have low haze characteristics. Haze is a measurement of the transmitted light scattered more than 2.50 from the axis of the incident light. The smaller the haze value, the lower the degree of cloudiness. The haze value of transparent articles coated from such coating compositions is preferably less than 5.5%, and more preferably less than 0.5%. The transparent articles are preferably optical lenses.

Successful implementation of the inventive processes can be easily checked, for example by coating a transparent optical article with a liquid coating solution comprising a dispersion of nanoparticles grafted according to the invention and measuring the haze value of the finished optical article.

Now, the present invention will be described in more detail with reference to the following examples. These examples are provided only for illustrating the present invention and should not be construed as limiting the scope and spirit of the present invention.

### EXAMPLES

1. General Methods

The process of the invention was performed in a vacuum treating machine comprising a plasma chamber and equipped with an evaporation device. The vacuum treating machine used was a PDG-32F Plasma Cleaner from Harrick Scientific with a VDE 0530 pump from Hanning Elektro-Werke. The evaporation device of this machine was composed of an elongated piece of steel wool connected on both sides to an electrical circuit.

The treatment with energetic species was a vacuum plasma treatment (treatment time: 5 minutes, 720 V DC, 25 mA DC, 18 W). The plasma used was a DC powered plasma (PDC-32F from Harrick Scientific).

The vacuum created for the plasma treatment was used to evaporate the phosphorous compound, namely diethylphosphatoethyl triethoxysilane. A current of 1.2 A was used for evaporation through Joule's effect (treatment time: 2 min).

The nanoparticles which were treated were a powder of Nb₂O₅ nanoparticles 14-15 nm in size.

Dispersions of the surface modified nanoparticles were prepared in aqueous ethanol and evaluated by realizing a coating from those dispersions and checking its transparency and level of haze.

The haze value of the finished optical article bearing such coating was measured by light transmission utilizing the Haze-Gard Plus haze meter from BYK-Gardner (a color difference meter) according to the method of ASTM D 1003, which is incorporated herein in its entirety by reference. All references to “haze” values in this application are by this standard. The instrument was first calibrated according to the manufacturer's directions. Next, the sample was placed on the transmission light beam of the pre-calibrated meter and the haze value was recorded from three different specimen locations and averaged.

2. Experimental Details

### Example 1

The nanoparticles as defined above were set in the vacuum chamber containing the evaporation device with some diethylphosphatoethyl triethoxysilane deposited on the piece of steel wool. The chamber was closed and the vacuum was pulled (26 Pa). The plasma treatment of the nanoparticles started when the correct pressure was attained. At the end of the treatment time, the plasma power was turned off, and the vacuum evaporation of diethylphosphatoethyl triethoxysilane was started by turning on the current for 5 minutes. The current was stopped and the vacuum was released.

The treated powder was then removed from the vacuum chamber and dispersed in a solution containing ethanol, 1N H₃PO₄, 2-diphenylphosphino benzoic acid and diethylphosphatoethyl triethoxysilane by mixing the solution for 15 minutes either with a bath sonicator, a high shear mixer or a magnetic stirrer. The amount of nanoparticles in the dispersion was 9.3% in weight.

A coating composition was made using 1.25 g of the above dispersion, 1.1 g of hydrolysed GLYMO (binder, obtained from 0.9 g of γ-glycidoxypropyl trimethoxysilane and 0.2 g of HCl 0.1N stirred for at least 30 min), 0.03 g of WRAPA (surfactant) and 0.1 g of TYZOR® DC (a titanium chelate used for delayed cross-linking).

A bare ORMA® plano lens from Essilor made of diethyleneglycol diallylcarbonate and having a thickness of 2.5 mm at center was spin coated at 800 rpm (rotations per minute) for 8 s and 1200 rpm for 10 s with the above coating composition. The coating was thermally cured for 3 hours at 80° C.

### Example 2 (Comparative)

Example 1 was repeated without plasma-treating the Nb₂O₅ nanoparticles.

### Example 3

Nb₂O₅ nanoparticles were treated according to example 1 and dispersed in a solution containing ethanol and diethylphosphatoethyl triethoxysilane. The amount of nanoparticles in the dispersion was 9.3% in weight.

A coating composition was made as described in example 1 using 1.25 g of the above dispersion.

A bare ORMA® lens from Essilor was spin coated with the above coating composition as described in example 1. The coating was thermally cured as described in example 1.

### Example 4 (Comparative)

Example 3 was repeated without plasma-treating the Nb₂O₅ nanoparticles.

3. Results

Haze values of the coated lenses are reported in Table 1.

TABLE 1

| | Example | | | |
|---|---|---|---|---|
| | 1 (invention) | 2 (comparative) | 3 (invention) | 4 (comparative) |
| Haze | 5.48 | 6.14 | 3.86 | 4.85 |
| value (%) | | | | |

Table 1 shows that a treatment of the nanoparticles with energetic species enables to obtain a dispersion from which a coated optical article with lower haze can be obtained.

It is worth noting that examples 1 and 3 disclose coating formulations, the composition of which can be optimized to decrease the haze value.

The inventive coating compositions were stable over several months as checked visually (no separation of phase was observed) and with the CHDF-2000 particle size analyzer from MATEC (no change of the particle size distribution was observed).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1.-15. (canceled)

16. A process for modifying the surface of nanoparticles, comprising:
providing nanoparticles, the surface of which has been activated by treatment with an energetic species; and
treating said nanoparticles with at least one gaseous phosphorus-containing compound having at least one functional group further defined as a phosphoric acid group, a phosphonic acid group, a phosphinic acid group, a phosphinous acid group, a phosphine group, a phosphine oxide group, a phosphite group, a phosphonium group, or a salt or derivative of any of these, wherein said treating results in chemical grafting of said phosphorus-containing compound on the surface of the nanoparticles.

17. The process of claim 16, wherein the nanoparticles have a particle size of less than or equal to 15 nm.

18. The process of claim 16, wherein the nanoparticles are metallic or metalloid oxide nanoparticles.

19. The process of claim 16, wherein the treatment with energetic species comprises a vacuum plasma treatment, an atmospheric pressure plasma treatment, a glow discharge plasma treatment, a corona discharge treatment, an ion beam bombardment, or an electron beam bombardment.

20. The process of claim 19, wherein the treatment with energetic species is a plasma treatment.

21. The process of claim 16, wherein the energetic species have an energy ranging from 1 to 150 eV.

22. The process of claim 16, wherein treating the nanoparticles with at least one gaseous phosphorus-containing compound is performed by vacuum evaporating the phosphorus-containing compound by means of an evaporation device.

23. The process of claim 22, wherein the evaporation device is adapted to perform ion or electron beam heating, high-frequency heating, optical heating, or cause a Joule effect during use.

24. The process of claim 22, wherein the evaporation device is a Joule effect device comprising an electrical circuit connected to a piece of steel wool onto which the at least one phosphorus-containing compound is deposited.

25. The process of claim 16, wherein the phosphorus-containing compound is phosphoric acid, phosphonic acid, phosphinic acid, phosphinous acid, hypophosphoric acid, a triarylphosphine, a phosphine oxide, a trialkylphosphite, a tetraaryl phosphonium, a phosphoramide, a phosphinimine, or a phosphine sulfide or a salt or derivative thereof.

26. The process of claim 16, wherein the phosphorus-containing compound comprises at least one sulfonic acid, sulfinic acid, carboxylic acid, isocyanate, vinyl, siloxane, or silane.

27. A method of preparation of a stabilized dispersion of nanoparticles, comprising:
obtaining modified nanoparticles preparable by the process of claim 16; and
dispersing the modified nanoparticles in a liquid medium to obtain a dispersion.

28. The method of claim 27, wherein said liquid medium comprises one or more phosphorus-containing compound comprising at least one functional group further defined as a phosphoric acid group, a phosphonic acid group, a phosphinic acid group, a phosphinous acid group, a phosphine group, a phosphine oxide group, a phosphite group, or a phosphonium group, or a salt or derivative thereof.

29. The method of claim 27, wherein the liquid medium is further defined as an aqueous medium.

30. The method of claim 27, wherein the dispersion is stable for at least one week at 25° C.

31. A method of coating an article comprising:
obtaining a coating composition comprising a modified nanoparticle preparable by the process of claim 16; and
coating an article with the coating composition.

32. The method of claim 31, wherein the article is further defined as an ophthalmic lens with a low haze value.
